(19) United States
(12) Patent Application Publication
(10) Pub. No.: US 2020/0082837 A1
(43) Pub. Date: Mar. 12, 2020

(54) CONCEALING PHRASES IN AUDIO TRAVELING OVER AIR

(71) Applicants: Munir Nikolai Alexander Georges, Kehl (DE); Joachim Hofer, Munich (DE); Tobias Bocklet, Kronach (DE); Josef Bauer, Munich (DE); Georg Stemmer, Munchen (DE)

(72) Inventors: Munir Nikolai Alexander Georges, Kehl (DE); Joachim Hofer, Munich (DE); Tobias Bocklet, Kronach (DE); Josef Bauer, Munich (DE); Georg Stemmer, Munchen (DE)

(21) Appl. No.: 16/683,686

(22) Filed: Nov. 14, 2019

(51) Int. Cl. G10L 21/02; G10L 15/02; G10L 15/22; G10L 15/197

(52) U.S. Cl. CPC G10L 21/0202; G10L 15/02; G10L 2015/088; G10L 15/197; G10L 2015/025; G10L 15/22

(57) ABSTRACT

An example apparatus for concealing phrases in audio includes a receiver to receive a detected phrase via a network. The detected phrase is based on audio captured near a source of an audio stream. The apparatus also includes a speech recognizer to generate a trigger in response to detecting that a section of the audio stream contains a confirmed phrase. The apparatus further includes a phrase concealer to conceal the section of the audio stream in response to the trigger.

### BACKGROUND

Bleeps may be used to conceal phrases such as profanity in audio. For example, a loud bleep noise may be used to mask a portion of an audio stream at which the profanity may be present.

### BRIEF DESCRIPTION OF THE DRAWINGS

FIG. 1 is a block diagram illustrating an example system for concealing phrases in audio traveling through air;

FIG. 2 is a state diagram illustrating an example phrase detector for detecting phrases in audio traveling through air;

FIG. 3 is a block diagram illustrating an example neuronal network for detecting phrases in audio traveling through air;

FIG. 4 is a flow chart illustrating a process for concealing phrases in audio traveling through air;

FIG. 5 is a timing diagram illustrating an example process for concealing phrases in audio traveling through air;

FIG. 6 is a flow chart illustrating a method for concealing phrases in audio traveling through air;

FIG. 7 is block diagram illustrating an example computing device that can conceal phrases in audio traveling through air; and

FIG. 8 is a block diagram showing computer readable media that store code for concealing phrases in audio traveling through air.

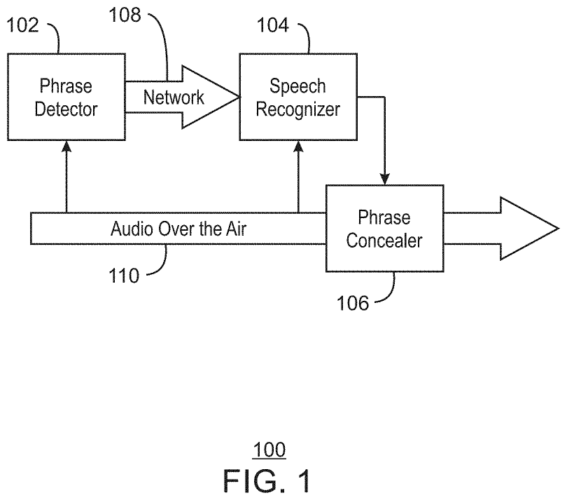

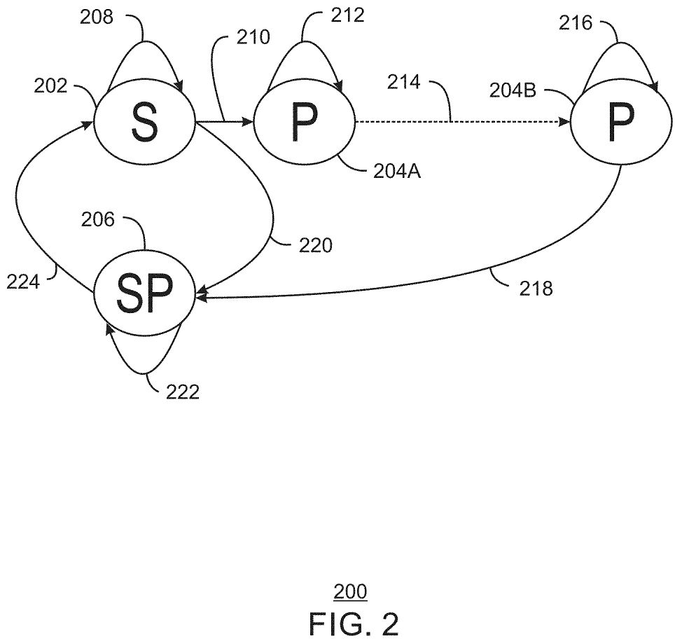

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Bleep concealing may be used to conceal phrases including profanity in audio. For example, an audio stream may be manually analyzed. Profanity may be marked and replaced with an electronic sound, referred to herein as a bleep, before broadcasting. The bleep sound may be a tone at a particular frequency. For example, the tone may be a high-pitched pure tone with overtones. However, manually analyzing signals is error-prone, especially in a time critical situation where an audio or video stream cannot be arbitrarily delayed. For example, a delay of about six seconds is used to prevent profanity, bloopers, nudity, or other undesirable material in telecasts of events on television and radio.

The present disclosure relates generally to techniques for concealing phrases in audio traveling over the air. For example, the phrases may include one or more words associated with profanity or any other language that is targeted for concealment. For example, the phrases may include passwords, secret codenames, names, etc. In some examples, the phrases may include key phrases. Specifically, the techniques described herein include an apparatus, method and system for concealing phrases in audio. An example apparatus includes a receiver to receive a detected phrase via a network, wherein the detected phrase is based on audio captured near a source of an audio stream. The apparatus also includes a speech recognizer to generate a trigger in response to detecting that a section of the audio stream contains a confirmed phrase. The apparatus further includes a phrase concealer to conceal the section of the audio stream in response to the trigger.

The techniques described herein thus reduce the amount of tape-delay used and the demand on manual analyzing of live audio events. The techniques ensure consistent quality of content. For example, the techniques may be used to fulfill regulatory requirements limiting public broadcasting of profane materials. In some examples, the techniques may be used in a live environment by utilizing the different speeds of transmission between sound over the air and phrase detection over the network. Thus, live audio may be concealed using generated bleep noises with little, if any, delay in amplifying the audio from a stage. For example, numerous phrase concealers, such as bleep generators, may be placed near an audience to mask any detected phrase with bleep noises as the phrase reaches the audience.

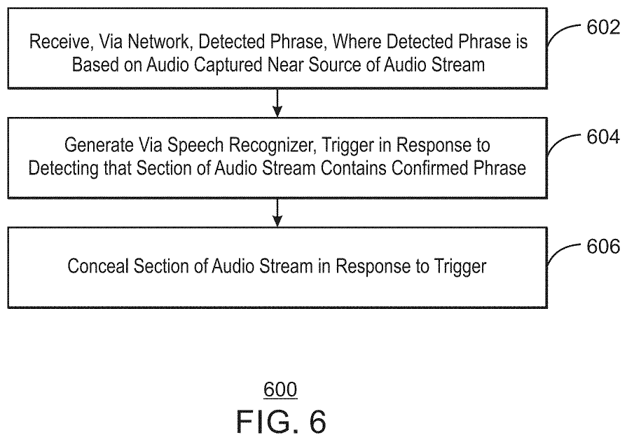

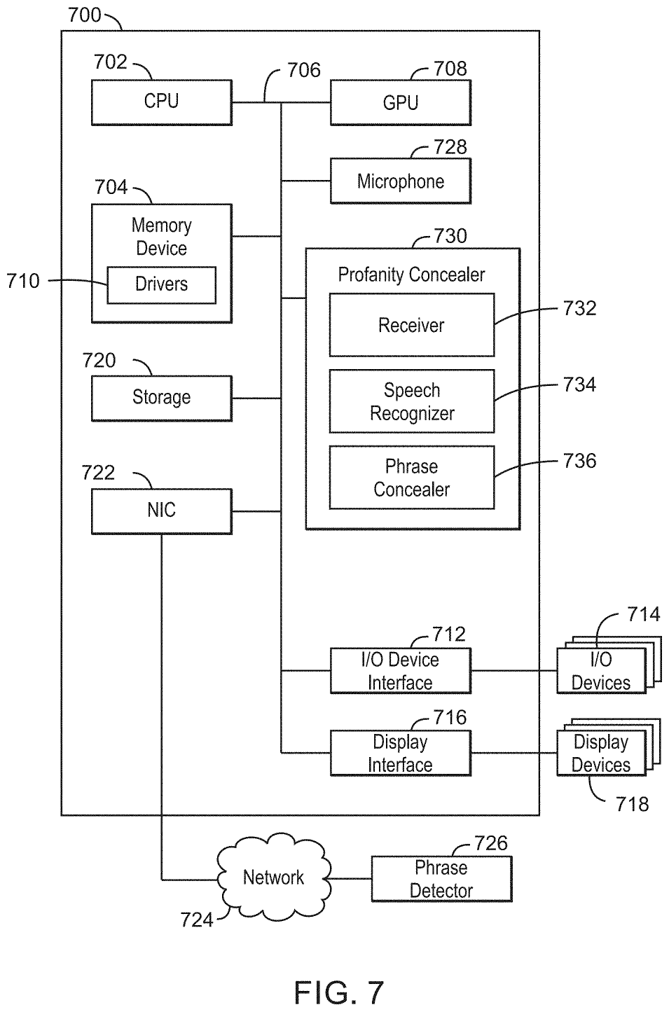

FIG. 1 is a block diagram illustrating an example system for concealing phrases in audio traveling through air. The example system 100 can be implemented in the computing device 700 in FIG. 7 using the method 600 of FIG. 6.

The example system 100 includes a phrase detector 102, a speech recognizer 104, and a phrase concealer 106. The speech recognizer 104 is communicatively coupled to the phrase detector 102 via a network 108. The phrase concealer 106 is also communicatively coupled to the speech recognizer 104. In some examples, the phrase concealer 106 may be in the same device as the speech recognizer 104. The system 100 includes an audio over the air 110 shown being received at both the phrase detector 102 and the speech recognizer 104. The phrase concealer 106 is shown covering a portion of the audio over the air 110. For example, the covered portion may include detected phrase.

In the system 100, the phrase detector 102 can monitor the audio over the air 110 and detect phrase candidates. In some examples, the phrase detector 102 can detect phrase candidates using an acoustic matching technique on sub-word units close to a source where the phrase was uttered. For example, the sub-word units may be phonemes. In some examples, the phrase detector 102 can parse detected sub-word units in the audio 110 and generates one or more phrase candidates. The phrase candidates may be one or more words that are may be profane in certain contexts. In various examples, phrase candidates may be single words with two or more syllables or multiple words. In order to reduce processing time at the phrase detector 102, the phrase detector 102 may only detect the phrase candidates rather than determining context. In various examples, the phrase detector 102 may run on an ultra-low power platform close to potential sources of a phrase. For example, the phrase detector 102 may be a device located near or on a stage. In some examples, the phrase detector 102 may be on a watch, laptop, or an intelligent microphone. In various examples, the phrase detector 102 may include neuronal network hardware acceleration to reduce latency related to execution. The detected phrase candidates are transmitted over a low latency network 108. For example, the network 108 may be a wired or wireless network, such as an Ethernet network or a 5G network.

In various examples, speech recognizer 104 may receive the detected phrase candidates over the network 108 before the audio over the air 110 arrives at the location of the speech recognizer 104 and phrase concealer 106. In some examples, this delay in the arrival of the audio over the air 110 enables the phrase concealer 106 to conceal the detected phrase in the original audio stream as the phrase arrives at the location of the phrase concealer 106. For example, the speech recognizer 104 may be executed at a device close to the target audience that is connected to the network 108. In various examples, the speech recognizer 104 may be running in low power. For example, the device may be a laptop or 2:1. For example, a 2:1 may be a laptop that is convertible into a hand-held touch screen device. In various examples, the speech recognizer 104 executes a natural language understanding engine in addition to a low-power speech recognizer. The use of a natural language understanding engine (NLU) may enable a more accurate prediction about the existence of phrases that are confirmed as profanity or otherwise not allowable in the audio 110. For example, the NLU uses more context information to make predictions, such as the words and sentences before the actual phrase. In some examples, sentimental information can be included. For example, a phrase may be likely to be a profanity if the sentence that is contained in is negative or aggressively formulated.

As one example, the speech recognizer 104 may be a large vocabulary speech recognition engine with a statistical language model that is trained on regular speech as well as on speech containing profanities. Such training may enable the speech recognizer 104 to detect the phrase more reliably. In some examples, the speech recognizer 104 also includes a time alignment unit that detects a precise beginning and end time of the phrase in the audio stream. For example, the time alignment unit can be implemented by computing phoneme lattices and determining the audio frame of the first and last phoneme of the phrase. In various examples, the speech recognizer 104 also contains a buffer. In various examples, the buffer is an ultra-low power audio buffer. For example, the ultra-low power audio buffer may be implemented as a ring-buffer. When the phrase detector 102 detects a candidate, this audio buffer may be used to supply audio context from words spoken before the detected candidate phrase. In this way, the speech recognizer 104 can utilize the acoustic and linguistic context in which the phrase was spoken.

In some examples, during normal operation, the phrase concealer 106 may receive the audio signal via air transmission at a predetermined amount of time after the audio signal is transmitted over the air. For example, the predetermined amount of time may be based on the distance of the phrase concealer 106 from the audio source. In some examples, a maximum amount of time that the phrase detector 102 and the speech recognizer 104 may use to detect a phrase relative to the beginning of the phrase. In response to receiving a trigger, the phrase concealer 106 can generate a noise, such as a bleep sound, to conceal the phrase detected section of the audio stream. In various examples, the phrase concealer 106 replaces or conceals the section of the audio signal with the phrase with a bleep or similar noise. For example, when a phrase is detected, the phrase concealer 106 overlays the audio with another signal. As one example, the signal may be a bleep that makes the phrase inaudible to nearby listeners. In various examples, the other signal may be any suitable noise signal. In other examples, the phrase concealer 106 may prevent a detection of the phrase at a device by disabling detection of the phrase at the device during the section of the audio.

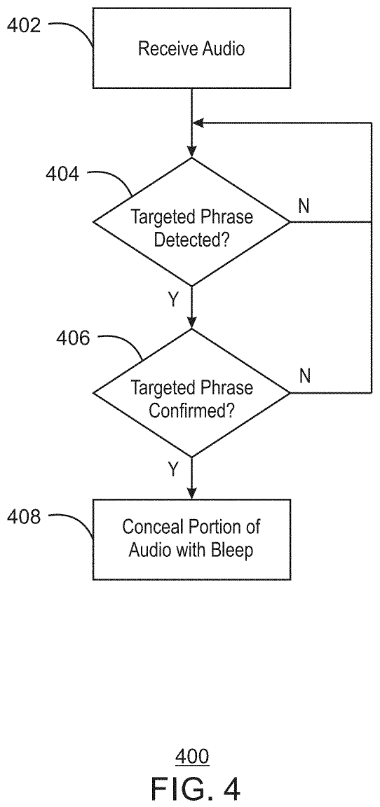

In various examples, the phrase detector 102, a speech recognizer 104, and a phrase concealer 106 may interact using events and each of the phrase detector 102, a speech recognizer 104, and a phrase concealer 106 has access to the audio stream 110. An example event handling between these components is described in FIG. 4.

The diagram of FIG. 1 is not intended to indicate that the example system 100 is to include all of the components shown in FIG. 1. Rather, the example system 100 can be implemented using fewer or additional components not illustrated in FIG. 1 (e.g., additional phrase concealers, speech recognizers, phrase detectors, audio sources, etc.). In some examples, the detected phrase candidates may be multi casted over the low latency network 108. For example, the phrase candidates may be sent over the low latency network 108 to multiple speech recognizers and phrase concealers.

FIG. 2 is a state diagram illustrating an example phrase detector for concealing phrases in audio traveling through air. The example phrase detector 200 can be implemented in the computing device 700 in FIG. 7 using the method 600 of FIG. 6.

The example phrase detector 200 includes states 202, 204A, 204B, and 206. State 202 refers to a state in which no speech is detected. States 204A and 204B are single sub-word units in which a phrase is detected. For example, each sub-word unit may represent a phoneme of a phrase. State 206 is a state in which speech is detected that is not part of the phrase to be detected. This state is also referred to as a garbage model. The phrase detector 200 further includes transitions 208, 210, 212, 214, 216, 218, 220, 222, and 224. Transition 208 indicates that the phrase detector 200 continually monitors for speech in received audio. Transition 210 indicates that the phrase detector 200 detects a candidate phrase leading to a state 204A in which the first sub-word unit of the phrase is detected. Transition 212 indicates that the first sub-word unit is still spoken. Because this transition may be taken a variable amount of times, the corresponding sub-word unit may be spoken at different speeds. The following state 204B represents the second sub-word unit of the phrase. For example, the state 204B may be a second phoneme. The transition 214 indicates the phrase detector 200 detecting the second phoneme of a phrase at the next state. There may be a variable number of “P” states based on the number of sub-word units in the phrase. Each of those states have a self-transition, such as transitions 212 or 216, that is used to model different lengths of sub-word units and a transition to the following state. Transition 216 indicates that the last sub-word unit of the phrase is continued to be spoken. The transition 218 indicates that the end of the phrase to be detected was reached, and the following speech is not related to the phrase. Transition 220 indicates that speech was detected after a segment of silence or non-speech noise. Transition 222 indicates that speech not relevant to the phrase is still detected. Transition 224 indicates that silence or non-speech noise was detected after a segment of speech.

In various examples, the phrase detector 200 can continuously try to find a best fitting hypothesis of traversed states based on the audio signal. For example, this may be achieved by assigning outputs of a deep neural network trained on speech data to the states of the diagram and a token passing algorithm. In some examples, if the probability of the hypothesis to be in state 204B is significantly larger than the probability of being in state 202 or state 206, then the phrase detector 200 can assume that the phrase has been spoken. Thus, the phrase detector 200 may trigger a phrase detection event if this difference of probabilities exceeds a predetermined threshold.

In various examples, the phrase detector 200 is implemented as a phrase spotter on most often used profanity word sequences. In some examples, the phrase spotter may re-use a wake-on-voice technology. In various examples, the phrase spotter makes use of a time asynchronous spoken intent detection for low power applications. For example, the phrase spotter can detect in-domain vocabulary and relative, quantized time stamps of previously spotted phrases of a continuous audio stream. The sequence of detected phrases and time stamps are used as features for an intent classification. The acoustic model of the phrase spotter can be used to automatically add time stamp information to the text data for intent classification training. In some examples, the phrase spotter may use an utterance-level wakeup on intent system from speech keywords. For example, the phrase spotter can use a sequence of keywords in a speech utterance to determine an intent. Instead of using the syntactical sequence of spotted keywords for intent classification, the phrase spotter can use a feature representation which is closer to the speech signal. As one example, the feature representation may include mel-frequency cepstral coefficient (MFCC) enhanced keyword features. This may enable low-power always-on systems that focus listening on relevant parts of an utterance. In some examples, the phrase detector 200 includes two parts. For example, the first part of the phrase detector 200 may be an audio to “word-units” recognizer that recognizes the most likely word unit sequence. For example, the word unit sequence may be a phoneme sequence. In some examples, the word unit sequence may be a word unit probability distribution. In some examples, the audio to “word-units” recognizer is combined with a non-speech and garbage modelling. Then, the recognized word units or word unit probability distribution may be input into a second component. In some examples, the phrase detector 200 may be implemented as an automatic speech recognizer is used together with a natural language understanding component.

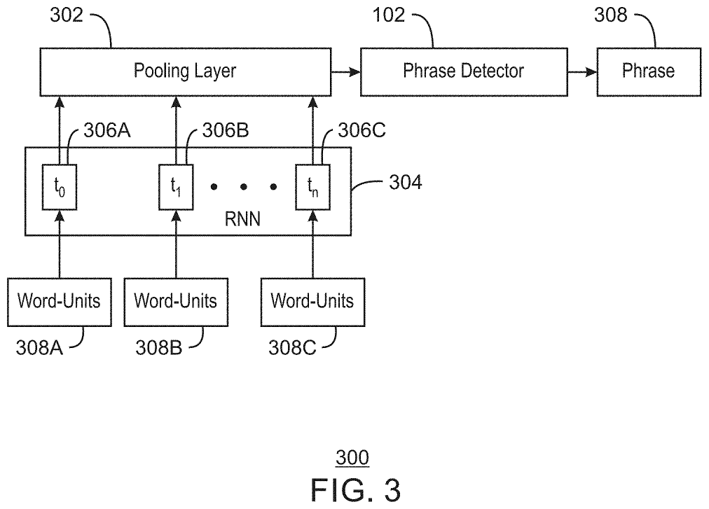

In various examples, the second component of the phrase detector 200 is a neuronal network. For example, the neuronal network may be a recurrent neuronal network that does the phrase detection, as described in the example of FIG. 3.

The diagram of FIG. 2 is not intended to indicate that the example phrase detector 200 is to include all of the components shown in FIG. 2. Rather, the example phrase detector 200 can be implemented using fewer or additional components not illustrated in FIG. 2 (e.g., additional states, transitions, etc.).

FIG. 3 is a block diagram illustrating an example neuronal network for concealing phrases in audio traveling through air. The example neuronal network 300 can be implemented in the computing device 700 in FIG. 7 using the method 600 of FIG. 6. For example, the neuronal network 300 may be used to implement the phrase detector 102 of FIG. 1 or the phrase detector 726 of FIG. 7.

The example neuronal network 300 includes a pooling layer 302 communicatively coupled to a phrase detector 102. For example, the pooling layer 302 may be an average pooling, a mean pooling, or a statistical pooling on n. In some examples, the phrase detector 102 may be a feed forward network. The neuronal network 300 also includes a recurrent neuronal network (RNN) 304. The RNN 304 includes a set of features 306A, 306B, 306C generated from a set of word-units 308A, 308B, and 308C received from a speech recognizer. For example, the word units 308A, 308B, and 308C are passed to the RNN 304, where each word unit 308A, 308B, and 308C is represented as a numerical vector. In some examples, the words are passed one after another up to the end of the sentence. The result of each time-step is passed to the pooling layer. In some examples, the dimension of the output vector can be changed depending on the needs as well as the topology of the RNN 304. For example, the RNN 304 may be a long short-term memory (LSTM) RNN. In some examples, the RNN 304 may be a Time Convolutional Network (TCN), such as a Time Delay Neural Network (TDNN). The output features 306A-306C are shown being input into a pooling layer 302. The output of the pooling layer 302 may be a vector with fixed dimensions. This output vector may be used by the phrase detector 102 to classify a phrase 308.

The diagram of FIG. 3 is not intended to indicate that the example neuronal network 300 is to include all of the components shown in FIG. 3. Rather, the example neuronal network 300 can be implemented using fewer or additional components not illustrated in FIG. 3 (e.g., additional word-units, features, pooling layers, phrase detectors, detected profanities, etc.).

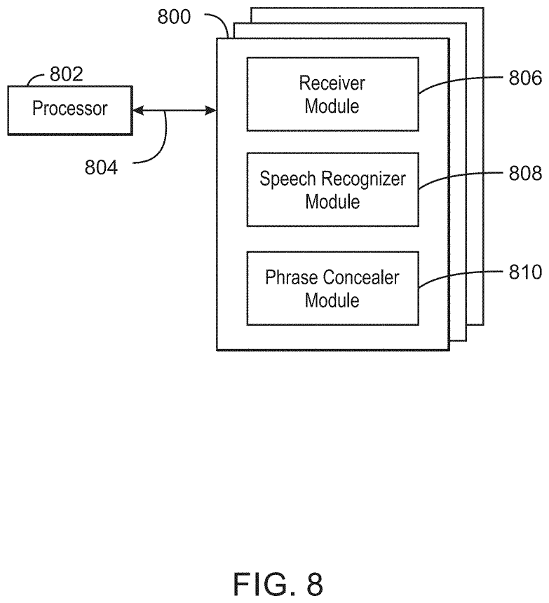

FIG. 4 is a flow chart illustrating an example process for concealing phrase in audio traveling through air. The example process 400 can be implemented in the system 100 of FIG. 1 using the phrase detector 200 of FIG. 2, the neuronal network 300 of FIG. 3, the computing device 700 in FIG. 7, or the computer readable media 800 of FIG. 8.

At block 402, a processor receives an audio. For example, the audio may be speech being amplified live at a venue. In some examples, the audio may be speech from a person in a large room.

At decision diamond 404, assigns each frame in the audio signal a probability of how likely a word was spoken that might be a phrase that is targeted to be concealed. If a certain threshold is exceeded, then the processor may multicast the detection over a network channel and the process may continue at decision diamond 406. If the threshold is not exceeded, then the process may continue at block 402, wherein additional audio is received.

At decision diamond 406, a processor determines whether a phrase is highly likely of being a targeted phrase. For example, a speech recognizer at a second place close to the audience may receive the detection. The speech recognizer may be triggered upon receipt of the detected phrase. In various examples, the speech recognizer starts re-evaluating the signal with higher granularity. For example, a finer granularity may be achieved by an acoustic model that has more hidden units or layers and is trained on more data. Such an acoustic model can capture more details out of an audio signal. In some examples, the same higher granularity can be applied for the language model or semantic model (NLU). The higher granularity evaluation may result in a higher classification accuracy. If the processor confirms the phrase is a targeted phrase via the higher accuracy classification, then the process may continue at block 408. If the processor does not confirm that the phrase is a targeted phrase, then the process may continue at block 402.

At block 408, the processor may generate a trigger signal for a phrase concealer to replace an audio snippet. For example, the trigger may be sent at a time that the audio snippet is to begin at the location of the second place close to the audience.

This process flow diagram is not intended to indicate that the blocks of the example process 400 are to be executed in any particular order, or that all of the blocks are to be included in every case. Further, any number of additional blocks not shown may be included within the example process 400, depending on the details of the specific implementation.

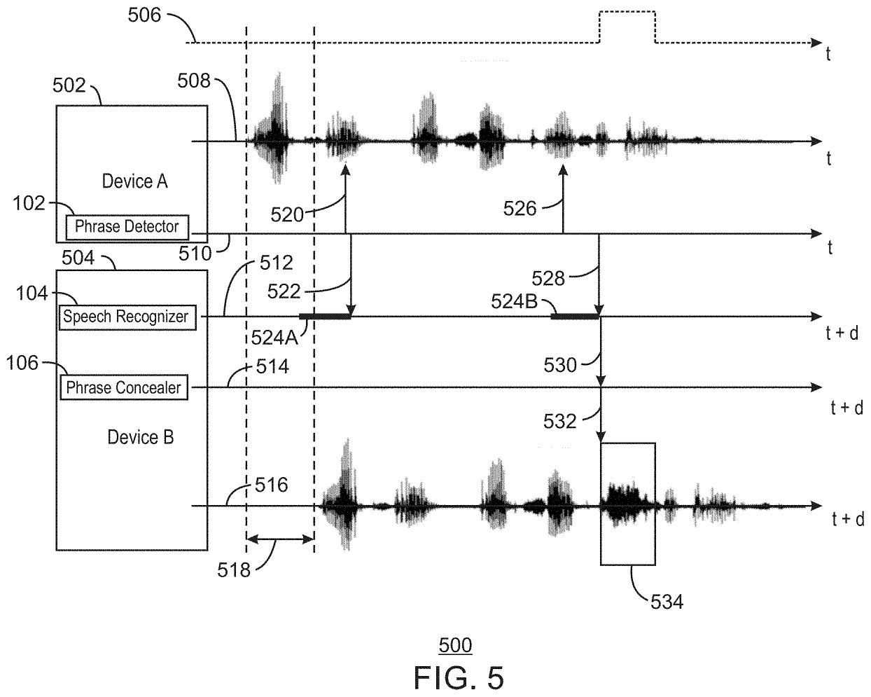

FIG. 5 is a timing diagram illustrating an example system for concealing phrases in audio traveling through air. The example process 500 can be implemented in the computing device 700 in FIG. 7 using the method 600 of FIG. 6.

The example process 500 includes a first device 502 communicatively coupled to a second device 504. The first device 502 includes a phrase detector 102. The second device 504 includes a speech recognizer 104 and a phrase concealer 106. A trigger signal 506 generated by the speech recognizer 104 is shown at the top of the timing diagram of FIG. 5. The timing diagram includes an audio signal 508 as captured by device 502. The timing diagram includes communication axes 510, 512, and 514, corresponding to the phrase detector 102, the speech recognizer 104, and the phrase concealer 106, respectively. As shown in FIG. 5, the communication axes 510, 512, and 514 incorporate a delay d in the timing t+d representing the delay at the transmission channel network versus transmission over the air. The timing diagram of FIG. 5 also includes a second audio signal 516 as detected near the phrase concealer 106. The second audio signal 516 has a delay 518 applied as compared to the timing audio signal 508 captured by device 502.

In the example of FIG. 5, the device 502 may be close to a source of speech. For example, device 502 may be located on a stage. Device 504 may be closer to the audience. For example, the device 504 may be at some distance on a stand. Hence, the audio has a delay 518 when traveling over the air from device 502 to device 504. The latency over the network is smaller than the latency d. For example, this condition may be fulfilled by placing device 502 away from device 504 in moderately large rooms or venues.

At time 520, the phrase detector 102 detects a candidate phrase in the audio signal 508. At time 522, the phrase detector 102 sends the detected candidate phrase over a network to the speech recognizer 104. The speech recognizer 104 then analyzes the candidate using the buffered speech 524A preceding the candidate as context. In the example of FIG. 5, the speech recognizer 104 takes no further action with respect to this first detected candidate. For example, the speech recognizer 104 may have detected that the first candidate phrase was not a targeted phrase based on the context.

At time 526, the phrase detector 102 detects a second candidate phrase in the audio signal 508. At time 528, the phrase detector 102 sends a second candidate phrase to the speech recognizer 104. At time 530, the speech recognizer 104 confirms a candidate phrase is a targeted phrase based on the buffered speech 524B and sends a trigger to the phrase concealer 106. The phrase concealer 106 generates a noise 534 to conceal the phrase as shown in the overlay portion 534 of signal 516. For example, the noise 534 may be a bleep sound. The trigger signal 506 shows a corresponding signal to the portion of the audio signal concealed by the noise 534.

The diagram of FIG. 5 is not intended to indicate that the example process 500 is to include all of the components shown in FIG. 5. Rather, the example process 500 can be implemented using fewer or additional components not illustrated in FIG. 5 (e.g., additional devices, signals, buffers, detected profanities, etc.).

FIG. 6 is a flow chart illustrating a method for concealing phrases in audio traveling through air. The example method 600 can be implemented in the system 100 of FIG. 1 using the phrase detector 200 of FIG. 2, the neuronal network 300 of FIG. 3, the computing device 700 in FIG. 7, or the computer readable media 800 of FIG. 8.

At block 602, a processor receives a detected phrase. The detected phrase is based on audio captured near a source of an audio stream. For example, the detected phrase may have a probability of being a target phrase that exceeds a threshold.

At block 604, the processor generates a trigger in response to detecting that a section of the audio stream contains a confirmed phrase. For example, the processor can a precise beginning and end time of the detected phrase in the audio stream. In some examples, the processor can compute phoneme lattices and determine an audio frame of a first phoneme and a last phoneme of the detected phrase. In various examples, the processor processes audio context from words spoken before the detected phrase.

At block 606, the processor conceals the section of the audio stream in response to the trigger. For example, the processor can overlay the audio signal with another signal in response to detecting the trigger. In various examples, the processor can preventing a detection of the phrase at a device by concealing the section of the audio stream. In some examples, the processor can prevent a detection of the phrase at a device by disabling detection of the phrase at the device during the section of the audio. In various examples, the processor can generate a noise to conceal the section of the audio stream. In some examples, the processor uses a delay in transmission of the audio signal over the air as an amount of time used to receive the detected phrase and confirm the detected phrase relative to a beginning of the detected phrase.

This process flow diagram is not intended to indicate that the blocks of the example method 600 are to be executed in any particular order, or that all of the blocks are to be included in every case. Further, any number of additional blocks not shown may be included within the example method 600, depending on the details of the specific implementation.

Referring now to FIG. 7, a block diagram is shown illustrating an example computing device that can conceal phrases in audio traveling through air. The computing device 700 may be, for example, a laptop computer, desktop computer, tablet computer, mobile device, or wearable device, among others. In some examples, the computing device 700 may be a laptop or a 2:1 device. For example, a 2:1 device may be a hybrid laptop with a detachable tablet component. The computing device 700 may include a central processing unit (CPU) 702 that is configured to execute stored instructions, as well as a memory device 704 that stores instructions that are executable by the CPU 702. The CPU 702 may be coupled to the memory device 704 by a bus 706. Additionally, the CPU 702 can be a single core processor, a multi-core processor, a computing cluster, or any number of other configurations. Furthermore, the computing device 700 may include more than one CPU 702. In some examples, the CPU 702 may be a system-on-chip (SoC) with a multi-core processor architecture. In some examples, the CPU 702 can be a specialized digital signal processor (DSP) used for image processing. The memory device 704 can include random access memory (RAM), read only memory (ROM), flash memory, or any other suitable memory systems. For example, the memory device 704 may include dynamic random access memory (DRAM).

The memory device 704 can include random access memory (RAM), read only memory (ROM), flash memory, or any other suitable memory systems. For example, the memory device 704 may include dynamic random access memory (DRAM).

The computing device 700 may also include a graphics processing unit (GPU) 708. As shown, the CPU 702 may be coupled through the bus 706 to the GPU 708. The GPU 708 may be configured to perform any number of graphics operations within the computing device 700. For example, the GPU 708 may be configured to render or manipulate graphics images, graphics frames, videos, or the like, to be displayed to a user of the computing device 700.

The memory device 704 can include random access memory (RAM), read only memory (ROM), flash memory, or any other suitable memory systems. For example, the memory device 704 may include dynamic random access memory (DRAM). The memory device 704 may include device drivers 710 that are configured to execute the instructions for training multiple convolutional neural networks to perform sequence independent processing. The device drivers 710 may be software, an application program, application code, or the like.

The CPU 702 may also be connected through the bus 706 to an input/output (I/O) device interface 712 configured to connect the computing device 700 to one or more I/O devices 714. The I/O devices 714 may include, for example, a keyboard and a pointing device, wherein the pointing device may include a touchpad or a touchscreen, among others. The I/O devices 714 may be built-in components of the computing device 700, or may be devices that are externally connected to the computing device 700. In some examples, the memory 704 may be communicatively coupled to I/O devices 714 through direct memory access (DMA).

The CPU 702 may also be linked through the bus 706 to a display interface 716 configured to connect the computing device 700 to a display device 718. The display device 718 may include a display screen that is a built-in component of the computing device 700. The display device 718 may also include a computer monitor, television, or projector, among others, that is internal to or externally connected to the computing device 700.

The computing device 700 also includes a storage device 720. The storage device 720 is a physical memory such as a hard drive, an optical drive, a thumbdrive, an array of drives, a solid-state drive, or any combinations thereof. The storage device 720 may also include remote storage drives.

The computing device 700 may also include a network interface controller (NIC) 722. The NIC 722 may be configured to connect the computing device 700 through the bus 706 to a network 724. The network 724 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

The computing device 700 is further communicatively coupled to a phrase detector 726 via the network 724. For example, the phrase detector 726 may include an audio to word unit recognizer to recognize word unit sequences. The phrase detector 726 may also include a neuronal network to detect phrases from the word units. The computing device 700 may receive detected profanities from the phrase detector 726.

The computing device 700 may also include a microphone 728. For example, the microphone 728 may include one or more sensors for detecting audio. In various examples, the microphone 728 may be used to monitor audio near the computing device 700.

The computing device 700 further includes a phrase concealer 730. For example, the phrase concealer 730 can be used to conceal phrases in audio. In some examples, the phrase concealer 730 can be used to prevent detection of phrases at devices, such as virtual assistant devices, by rendering the offending phrase inaudible. The phrase concealer 730 can include a receiver 732, speech recognizer 734, and a phrase concealer 736. In some examples, each of the components 732-736 of the phrase concealer 730 may be a microcontroller, embedded processor, or software module. The receiver 732 can receive a detected phrase via a network, wherein the detected phrase is based on audio captured near a source of an audio stream. The speech recognizer 734 can generate a trigger in response to detecting that a section of the audio stream contains a confirmed phrase. For example, the speech recognizer 734 may include a vocabulary speech recognition engine with a statistical language model trained on regular speech and speech that contains profanities. In some examples, the speech recognizer 734 includes a time alignment unit to detect a precise beginning and end time of the detected phrase in the audio stream. In various examples, the speech recognizer 734 includes a time alignment unit to compute phoneme lattices and determine an audio frame of a first phoneme and a last phoneme of the detected phrase. In some examples, the speech recognizer 734 includes a buffer to supply audio context from words spoken before the detected phrase. For example, the speech recognizer 734 includes ultra-low power audio buffer. The phrase concealer 736 can conceal the section of the audio stream in response to the trigger. In some examples, the phrase concealer 736 can delay the audio signal by an amount of time the speech recognizer uses to receive the detected phrase and confirm the detected phrase relative to a beginning of the detected phrase. In various examples, the phrase concealer 736 can overlay the audio signal with another signal in response to detecting the trigger. In some examples, the phrase concealer 736 can prevent a detection of the phrase at a device by concealing the section of the audio stream. In various examples, the phrase concealer 736 can generate a noise to conceal the section of the audio stream.

The block diagram of FIG. 7 is not intended to indicate that the computing device 700 is to include all of the components shown in FIG. 7. Rather, the computing device 700 can include fewer or additional components not illustrated in FIG. 7, such as additional buffers, additional processors, and the like. The computing device 700 may include any number of additional components not shown in FIG. 7, depending on the details of the specific implementation. Furthermore, any of the functionalities of the receiver 732, the speech recognizer 734, and the phrase concealer 736, may be partially, or entirely, implemented in hardware and/or in the processor 702. For example, the functionality may be implemented with an application specific integrated circuit, in logic implemented in the processor 702, or in any other device. In addition, any of the functionalities of the CPU 702 may be partially, or entirely, implemented in hardware and/or in a processor. For example, the functionality of the phrase concealer 730 may be implemented with an application specific integrated circuit, in logic implemented in a processor, in logic implemented in a specialized graphics processing unit such as the GPU 708, or in any other device.

FIG. 8 is a block diagram showing computer readable media 800 that store code for concealing phrases in audio traveling through air. The computer readable media 800 may be accessed by a processor 802 over a computer bus 804. Furthermore, the computer readable medium 800 may include code configured to direct the processor 802 to perform the methods described herein. In some embodiments, the computer readable media 800 may be non-transitory computer readable media. In some examples, the computer readable media 800 may be storage media.

The various software components discussed herein may be stored on one or more computer readable media 800, as indicated in FIG. 8. For example, a receiver module 806 may be configured to receive a detected phrase via a network, wherein the detected phrase is based on audio captured near a source of an audio stream. A speech recognizer module 808 may be configured to generate a trigger in response to detecting that a section of the audio stream contains a confirmed phrase. For example, the speech recognizer module 808 may include code to detect a precise beginning and end time of the detected phrase in the audio stream. In some examples, the speech recognizer module 808 may include code to compute phoneme lattices and determine an audio frame of a first phoneme and a last phoneme of the detected phrase. A phrase concealer module 810 may be configured to conceal the section of the audio stream in response to the trigger. In some examples, the phrase concealer module 810 may be configured to detect a delay in the audio signal transmitted over the air and use this delay as an amount of time used to receive the detected phrase and confirm the detected phrase relative to a beginning of the detected phrase. In various examples, the phrase concealer module 810 may be configured to prevent a detection of the phrase at a device by disabling detection of the phrase at the device during the section of the audio. In some examples, the phrase concealer 810 may be configured to overlay the audio signal with another signal in response to detecting the trigger. In various examples, the phrase concealer 810 may be configured to prevent a detection of the phrase at a device by concealing the section of the audio stream. In some examples, the phrase concealer 810 may be configured to prevent a detection of the phrase at a device by disabling detection of the phrase at the device during the section of the audio. In various examples, the phrase concealer 810 may be configured to generate a noise to conceal the section of the audio stream.

The block diagram of FIG. 8 is not intended to indicate that the computer readable media 800 is to include all of the components shown in FIG. 8. Further, the computer readable media 800 may include any number of additional components not shown in FIG. 8, depending on the details of the specific implementation. For example, the computer readable media 800 may also be configured to detect that the phrase has a probability of being a target phrase that exceeds a threshold

### Examples

Example 1 is an apparatus for concealing phrases in audio. The apparatus includes a receiver to receive a detected phrase via a network. The detected phrase is based on audio captured near a source of an audio stream. The apparatus also includes a speech recognizer to generate a trigger in response to detecting that a section of the audio stream contains a confirmed phrase. The apparatus further includes a phrase concealer to conceal the section of the audio stream in response to the trigger.

Example 2 includes the apparatus of example 1, including or excluding optional features. In this example, the speech recognizer comprises vocabulary speech recognition engine with a statistical language model trained on regular speech and speech that contains profanities.

Example 3 includes the apparatus of any one of examples 1 to 2, including or excluding optional features. In this example, the speech recognizer comprises a time alignment unit to detect a precise beginning and end time of the detected phrase in the audio stream.

Example 4 includes the apparatus of any one of examples 1 to 3, including or excluding optional features. In this example, the speech recognizer comprises a time alignment unit to compute phoneme lattices and determine an audio frame of a first phoneme and a last phoneme of the detected phrase.

Example 5 includes the apparatus of any one of examples 1 to 4, including or excluding optional features. In this example, the speech recognizer comprises a buffer to supply audio context from words spoken before the detected phrase.

Example 6 includes the apparatus of any one of examples 1 to 5, including or excluding optional features. In this example, the speech recognizer comprises an ultra-low power audio buffer.

Example 7 includes the apparatus of any one of examples 1 to 6, including or excluding optional features. In this example, a detected delay of the audio signal due to transmission over the air is used as an amount of time the speech recognizer uses to receive the detected phrase and confirm the detected phrase relative to a beginning of the detected phrase.

Example 8 includes the apparatus of any one of examples 1 to 7, including or excluding optional features. In this example, the phrase concealer is to overlay the audio signal with another signal in response to detecting the trigger.

Example 9 includes the apparatus of any one of examples 1 to 8, including or excluding optional features. In this example, the phrase concealer is to prevent a detection of the phrase at a device by concealing the section of the audio stream.

Example 10 includes the apparatus of any one of examples 1 to 9, including or excluding optional features. In this example, the phrase concealer is to generate a noise to conceal the section of the audio stream.

Example 11 is a method for concealing phrases in audio. The method includes receiving, via a processor, a detected phrase via a network. The detected phrase is based on audio captured near a source of an audio stream. The method also includes generating, via the processor, a trigger in response to detecting that a section of the audio stream contains a confirmed phrase. The method further includes concealing, via the processor, the section of the audio stream in response to the trigger.

Example 12 includes the method of example 11, including or excluding optional features. In this example, the detected phrase has a probability of being a target phrase that exceeds a threshold.

Example 13 includes the method of any one of examples 11 to 12, including or excluding optional features. In this example, generating the trigger comprises detecting a precise beginning and end time of the detected phrase in the audio stream.

Example 14 includes the method of any one of examples 11 to 13, including or excluding optional features. In this example, generating the trigger comprises computing phoneme lattices and determine an audio frame of a first phoneme and a last phoneme of the detected phrase.

Example 15 includes the method of any one of examples 11 to 14, including or excluding optional features. In this example, detecting that the section of the audio stream contains the confirmed phrase comprises processing audio context from words spoken before the detected phrase.

Example 16 includes the method of any one of examples 11 to 15, including or excluding optional features. In this example, the method includes detecting a delay of the audio signal due to transmission over air and using the delay as an amount of time the speech recognizer uses to receive the detected phrase and confirm the detected phrase relative to a beginning of the detected phrase.

Example 17 includes the method of any one of examples 11 to 16, including or excluding optional features. In this example, concealing the section of the audio stream comprises overlaying the audio signal with another signal in response to detecting the trigger.

Example 18 includes the method of any one of examples 11 to 17, including or excluding optional features. In this example, concealing the section of the audio stream comprises preventing a detection of the phrase at a device by concealing the section of the audio stream.

Example 19 includes the method of any one of examples 11 to 18, including or excluding optional features. In this example, concealing the section of the audio stream comprises preventing a detection of the phrase at a device by disabling detection of the phrase at the device during the section of the audio.

Example 20 includes the method of any one of examples 11 to 19, including or excluding optional features. In this example, concealing the section of the audio stream comprises generating a noise to conceal the section of the audio stream.

Example 21 is at least one computer readable medium for concealing phrases in audio having instructions stored therein that direct the processor to receive a detected phrase via a network. The detected phrase is based on audio captured near a source of an audio stream. The computer-readable medium also includes instructions that direct the processor to generate a trigger in response to detecting that a section of the audio stream contains a confirmed phrase. The computer-readable medium further includes instructions that direct the processor to conceal the section of the audio stream in response to the trigger.

Example 22 includes the computer-readable medium of example 21, including or excluding optional features. In this example, the computer-readable medium includes instructions to detect a precise beginning and end time of the detected phrase in the audio stream.

Example 23 includes the computer-readable medium of any one of examples 21 to 22, including or excluding optional features. In this example, the computer-readable medium includes instructions to compute phoneme lattices and determine an audio frame of a first phoneme and a last phoneme of the detected phrase.

Example 24 includes the computer-readable medium of any one of examples 21 to 23, including or excluding optional features. In this example, the computer-readable medium includes instructions to detect a delay in the audio signal due to transmission over air and use the delay as an amount of time the speech recognizer uses to receive the detected phrase and confirm the detected phrase relative to a beginning of the detected phrase.

Example 25 includes the computer-readable medium of any one of examples 21 to 24, including or excluding optional features. In this example, the computer-readable medium includes instructions to prevent a detection of the phrase at a device by disabling detection of the phrase at the device during the section of the audio.

Example 26 includes the computer-readable medium of any one of examples 21 to 25, including or excluding optional features. In this example, the computer-readable medium includes instructions to detect that the phrase has a probability of being a target phrase that exceeds a threshold.

Example 27 includes the computer-readable medium of any one of examples 21 to 26, including or excluding optional features. In this example, the computer-readable medium includes instructions to overlay the audio signal with another signal in response to detecting the trigger.

Example 28 includes the computer-readable medium of any one of examples 21 to 27, including or excluding optional features. In this example, the computer-readable medium includes instructions to prevent a detection of the phrase at a device by concealing the section of the audio stream.

Example 29 includes the computer-readable medium of any one of examples 21 to 28, including or excluding optional features. In this example, the computer-readable medium includes instructions to prevent a detection of the phrase at a device by disabling detection of the phrase at the device during the section of the audio.

Example 30 includes the computer-readable medium of any one of examples 21 to 29, including or excluding optional features. In this example, the computer-readable medium includes instructions to generate a noise to conceal the section of the audio stream.

Example 31 is a system for concealing phrases in audio. The system includes a receiver to receive a detected phrase via a network. The detected phrase is based on audio captured near a source of an audio stream. The system also includes a speech recognizer to generate a trigger in response to detecting that a section of the audio stream contains a confirmed phrase. The system further includes a phrase concealer to conceal the section of the audio stream in response to the trigger.

Example 32 includes the system of example 31, including or excluding optional features. In this example, the speech recognizer comprises vocabulary speech recognition engine with a statistical language model trained on regular speech and speech that contains profanities.

Example 33 includes the system of any one of examples 31 to 32, including or excluding optional features. In this example, the speech recognizer comprises a time alignment unit to detect a precise beginning and end time of the detected phrase in the audio stream.

Example 34 includes the system of any one of examples 31 to 33, including or excluding optional features. In this example, the speech recognizer comprises a time alignment unit to compute phoneme lattices and determine an audio frame of a first phoneme and a last phoneme of the detected phrase.

Example 35 includes the system of any one of examples 31 to 34, including or excluding optional features. In this example, the speech recognizer comprises a buffer to supply audio context from words spoken before the detected phrase.

Example 36 includes the system of any one of examples 31 to 35, including or excluding optional features. In this example, the speech recognizer comprises an ultra-low power audio buffer.

Example 37 includes the system of any one of examples 31 to 36, including or excluding optional features. In this example, a detected delay of the audio signal due to transmission over the air is used as an amount of time the speech recognizer uses to receive the detected phrase and confirm the detected phrase relative to a beginning of the detected phrase.

Example 38 includes the system of any one of examples 31 to 37, including or excluding optional features. In this example, the phrase concealer is to overlay the audio signal with another signal in response to detecting the trigger.

Example 39 includes the system of any one of examples 31 to 38, including or excluding optional features. In this example, the phrase concealer is to prevent a detection of the phrase at a device by concealing the section of the audio stream.

Example 40 includes the system of any one of examples 31 to 39, including or excluding optional features. In this example, the phrase concealer is to generate a noise to conceal the section of the audio stream.

Example 41 is a system for concealing phrases in audio. The system includes means for receiving a detected phrase via a network. The detected phrase is based on audio captured near a source of an audio stream. The system also includes means for generating a trigger in response to detecting that a section of the audio stream contains a confirmed phrase. The system further includes means for concealing the section of the audio stream in response to the trigger.

Example 42 includes the system of example 41, including or excluding optional features. In this example, the means for generating the trigger comprises vocabulary speech recognition engine with a statistical language model trained on regular speech and speech that contains profanities.

Example 43 includes the system of any one of examples 41 to 42, including or excluding optional features. In this example, the means for generating the trigger comprises a time alignment unit to detect a precise beginning and end time of the detected phrase in the audio stream.

Example 44 includes the system of any one of examples 41 to 43, including or excluding optional features. In this example, the means for generating the trigger comprises a time alignment unit to compute phoneme lattices and determine an audio frame of a first phoneme and a last phoneme of the detected phrase.

Example 45 includes the system of any one of examples 41 to 44, including or excluding optional features. In this example, the means for generating the trigger comprises a buffer to supply audio context from words spoken before the detected phrase.

Example 46 includes the system of any one of examples 41 to 45, including or excluding optional features. In this example, the means for generating the trigger comprises an ultra-low power audio buffer.

Example 47 includes the system of any one of examples 41 to 46, including or excluding optional features. In this example, a detected delay of the audio signal due to transmission over the air is used as an amount of time the means for generating the trigger uses to receive the detected phrase and confirm the detected phrase relative to a beginning of the detected phrase.

Example 48 includes the system of any one of examples 41 to 47, including or excluding optional features. In this example, the means for concealing the section of the audio stream is to overlay the audio signal with another signal in response to detecting the trigger.

Example 49 includes the system of any one of examples 41 to 48, including or excluding optional features. In this example, the means for concealing the section of the audio stream is to prevent a detection of the phrase at a device by concealing the section of the audio stream.

Example 50 includes the system of any one of examples 41 to 49, including or excluding optional features. In this example, the means for concealing the section of the audio stream is to generate a noise to conceal the section of the audio stream.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for concealing phrases in audio, comprising:
a receiver to receive a detected phrase via a network, wherein the detected phrase is based on audio captured near a source of an audio stream;
a speech recognizer to generate a trigger in response to detecting that a section of the audio stream contains a confirmed phrase; and
a phrase concealer to conceal the section of the audio stream in response to the trigger.

2. The apparatus of claim 1, wherein the speech recognizer comprises vocabulary speech recognition engine with a statistical language model trained on regular speech and speech that contains profanities.

3. The apparatus of claim 1, wherein the speech recognizer comprises a time alignment unit to detect a precise beginning and end time of the detected phrase in the audio stream.

4. The apparatus of claim 1, wherein the speech recognizer comprises a time alignment unit to compute phoneme lattices and determine an audio frame of a first phoneme and a last phoneme of the detected phrase.

5. The apparatus of claim 1, wherein the speech recognizer comprises a buffer to supply audio context from words spoken before the detected phrase.

6. The apparatus of claim 1, wherein the speech recognizer comprises an ultra-low power audio buffer.

7. The apparatus of claim 1, wherein a detected delay of the audio signal due to transmission over the air is used as an amount of time the speech recognizer uses to receive the detected phrase and confirm the detected phrase relative to a beginning of the detected phrase.

8. The apparatus of claim 1, wherein the phrase concealer is to overlay the audio signal with another signal in response to detecting the trigger.

9. The apparatus of claim 1, wherein the phrase concealer is to prevent a detection of the phrase at a device by concealing the section of the audio stream.

10. The apparatus of claim 1, wherein the phrase concealer is to generate a noise to conceal the section of the audio stream.

11. A method for concealing phrases in audio, comprising:
receiving, via a processor, a detected phrase via a network, wherein the detected phrase is based on audio captured near a source of an audio stream;
generating, via the processor, a trigger in response to detecting that a section of the audio stream contains a confirmed phrase; and
concealing, via the processor, the section of the audio stream in response to the trigger.

12. The method of claim 11, wherein the detected phrase has a probability of being a target phrase that exceeds a threshold.

13. The method of claim 11, wherein generating the trigger comprises detecting a precise beginning and end time of the detected phrase in the audio stream.

14. The method of claim 11, wherein generating the trigger comprises computing phoneme lattices and determine an audio frame of a first phoneme and a last phoneme of the detected phrase.

15. The method of claim 11, wherein detecting that the section of the audio stream contains the confirmed phrase comprises processing audio context from words spoken before the detected phrase.

16. The method of claim 11, comprising detecting a delay of the audio signal due to transmission over air and using the delay as an amount of time used to receive the detected phrase and confirm the detected phrase relative to a beginning of the detected phrase.

17. The method of claim 11, wherein concealing the section of the audio stream comprises overlaying the audio signal with another signal in response to detecting the trigger.

18. The method of claim 11, wherein concealing the section of the audio stream comprises preventing a detection of the phrase at a device by concealing the section of the audio stream.

19. The method of claim 11, wherein concealing the section of the audio stream comprises preventing a detection of the phrase at a device by disabling detection of the phrase at the device during the section of the audio.

20. The method of claim 11, wherein concealing the section of the audio stream comprises generating a noise to conceal the section of the audio stream.

21. At least one computer readable medium for concealing phrases in audio having instructions stored therein that, in response to being executed on a computing device, cause the computing device to:
receive a detected phrase via a network, wherein the detected phrase is based on audio captured near a source of an audio stream;
generate a trigger in response to detecting that a section of the audio stream contains a confirmed phrase; and
conceal the section of the audio stream in response to the trigger.

22. The at least one computer readable medium of claim 21, comprising instructions to detect a precise beginning and end time of the detected phrase in the audio stream.

23. The at least one computer readable medium of claim 21, comprising instructions to compute phoneme lattices and determine an audio frame of a first phoneme and a last phoneme of the detected phrase.

24. The at least one computer readable medium of claim 21, comprising instructions to detect a delay in the audio signal due to transmission over air and using the delay as an amount of time the speech recognizer uses to receive the detected phrase and confirm the detected phrase relative to a beginning of the detected phrase.

25. The at least one computer readable medium of claim 21, comprising instructions to prevent a detection of the phrase at a device by disabling detection of the phrase at the device during the section of the audio.
